(19) United States
(12) Patent Application Publication
(10) Pub. No.: US 2026/0138198 A1
(43) Pub. Date: May 21, 2026

(54) CUTTING AND SCRAP EJECTOR SYSTEM FOR PANEL

(71) Applicant: Ford Global Technologies, LLC, Dearborn, MI (US)

(72) Inventors: Michael Dunn, Westland, MI (US); Daniel Pfeffer, Farmingtyon Hills, MI (US); Philip Trinh, Royal Oak, MI (US); Richard Brinkley, Detroit, MI (US); Chris Schultz, Milford, MI (US); Evangelos Liasi, Royal Oak, MI (US)

(73) Assignee: Ford Global Technologies, LLC, Dearborn, MI (US)

(21) Appl. No.: 18/953,182

(22) Filed: Nov. 20, 2024

(51) Int. Cl. B23D 33/08; B23D 33/02

(52) U.S. Cl. CPC B23D 33/08; B23D 33/02

(57) ABSTRACT

A cutting and scrap ejector system for a panel includes a lower post, a main pad, a cutting member and a plunger. The main pad is configured to cooperate with the lower post to grip the panel. The cutting member is movable between a non-cutting position in which the cutting member is configured to be spaced apart from the panel and a cutting position in which the cutting member is configured to trim the panel. The plunger is movably coupled to the main pad between a first position in which the plunger is configured to be spaced apart from the panel and a second position in which the plunger is configured to contact a portion of the panel to eject the portion of the panel from the system. The plunger is inhibited from contacting the portion of the panel prior to the cutting member being moved to the cutting position.

### FIELD

The present disclosure relates to a cutting and scrap ejector system for a panel.

### BACKGROUND

The statements in this section merely provide background information related to the present disclosure and may not constitute prior art.

After a workpiece (e.g., a panel) has been formed in a die tool, the scrap portion of the workpiece needs to be ejected, and the formed workpiece needs to be removed from the die tool such that another workpiece may be loaded and formed. Ejecting the scrap portion and removing the formed workpiece from the die tool can be challenging due to characteristics of the workpiece. That is, the workpiece may have a shape that makes ejecting the scrap portion and removing the formed workpiece challenging without causing the die tool to malfunction.

These issues related to forming a workpiece and ejecting the workpiece from the system, among other issues related to preparing the workpiece, are addressed by the present disclosure.

### SUMMARY

This section provides a general summary of the disclosure and is not a comprehensive disclosure of its full scope or all of its features.

In one form, the present disclosure provides a cutting and scrap ejector system for a panel that includes a lower post, a main pad, a cutting member and a plunger. The lower post is configured to at least partially support the panel. The main pad is configured to cooperate with the lower post to grip the panel. The cutting member is movable between a non-cutting position in which the cutting member is configured to be spaced apart from the panel and a cutting position in which the cutting member is configured to trim the panel. The cutting member is movable to the cutting position in response to the main pad and the lower post gripping the panel. The plunger is movably coupled to the main pad between a first position in which the plunger is configured to be spaced apart from the panel and a second position in which the plunger is configured to contact a portion of the panel to eject the portion of the panel from the system. The plunger is moved to the second position once the cutting member is moved to the cutting position. The plunger is inhibited from contacting the portion of the panel prior to the cutting member being moved to the cutting position.

In variations of the system of the above paragraph, which can be implemented individually or in any combination: the system further includes a striker plate configured to contact the plunger and move the plunger from the first position toward the second position; the plunger is adjustable in a vertical direction relative to the main pad; the plunger extends through the cutting member; the system further includes a bushing disposed within an opening of the cutting member, the plunger extending through the bushing; the system further includes at least one nut threadably engaged to the plunger and configured to adjust the plunger in a vertical direction relative to the main pad; a first nut threadably engaged to the plunger and disposed below the main pad and a second nut threadably engaged to the plunger and disposed above the main pad, the first nut and the second nut cooperate to couple the plunger to the main pad; the system further includes a biasing member coupled to the plunger and disposed at least partially within the main pad, the biasing member configured to bias the plunger towards the first position; and a nut threadably engaged to the plunger and a washer adjacent to the nut, the biasing member coupled to the washer to couple the plunger to the main pad and bias the plunger towards the first position.

In another form, the present disclosure provides a cutting and scrap ejector system for a panel that includes a lower post, a main pad, a cutting member, a plunger, a bushing, and a striker plate. The lower post is configured to at least partially support the panel. The main pad is configured to cooperate with the lower post to grip the panel. The cutting member is movable between a non-cutting position in which the cutting member is configured to be spaced apart from the panel and a cutting position in which the cutting member is configured to trim the panel. The cutting member is movable to the cutting position in response to the main pad and the lower post gripping the panel. The plunger is movably coupled to the main pad between a first position in which the plunger is configured to be spaced apart from the panel and a second position in which the plunger is configured to contact a portion of the panel to eject the portion of the panel from the system. The plunger is moved to the second position once the cutting member is moved to the cutting position. The plunger is inhibited from contacting the portion of the panel prior to the cutting member being moved to the cutting position. The bushing is disposed within an opening of the cutting member. The plunger extending through the bushing. The striker plate is configured to contact the plunger and move the plunger from the first position toward the second position.

In variations of the system of the above paragraph, which can be implemented individually or in any combination: the plunger is adjustable in a vertical direction relative to the main pad; the plunger extends through the cutting member; the system further includes at least one nut threadably engaged to the plunger and configured to adjust the plunger in a vertical direction relative to the main pad; a first nut threadably engaged to the plunger and disposed below the main pad and a second nut threadably engaged to the plunger and disposed above the main pad, the first nut and the second nut cooperate to couple the plunger to the main pad; the system further includes a biasing member coupled to the plunger and disposed at least partially within the main pad, the biasing member configured to bias the plunger towards the first position; and a nut threadably engaged to the plunger and a washer adjacent to the nut, the biasing member coupled to the washer to couple the plunger to the main pad and bias the plunger towards the first position.

In yet another form, the present disclosure provides a method for trimming and ejecting a body in a system. The method includes placing the body between a main pad of the scrap ejector system and a lower post of the scrap ejector system such that the main pad and the lower post cooperate to grip the body, moving a cutting member between a non-cutting position in which the cutting member is configured to be spaced apart from the body and a cutting position in which the cutting member is configured to trim the body, and moving a plunger between a first position in which the plunger is configured to be spaced apart from the body and a second position in which the plunger is configured to contact a portion of the body to eject the portion of the body from the system. The plunger is inhibited from contacting the portion of the body prior to the cutting member being moved to the cutting position. The cutting member is movable to the cutting position in response to the main pad and the lower post gripping the body.

In variations of the method of the above paragraph, which can be implemented individually or in any combination: at least one nut is threadably engaged to the plunger and configured to adjust the plunger in a vertical direction relative to the main pad; the plunger is adjustable in a vertical direction relative to the main pad; and the method further includes biasing the plunger towards the first position using a biasing element and moving a striker plate into engagement with the plunger to overcome a biasing force and move the plunger from the first position towards the second position, the plunger being moved to the second position once the cutting member is moved to the cutting position.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic view of a cutting and scrap ejector system according to the principles of the present disclosure;

FIG. 2 is a schematic view of the cutting and scrap ejector system of FIG. 1 gripping a panel;

FIG. 3 is a schematic view of the cutting and scrap ejector system of FIG. 1 with a cutting member of the system being moved to the cutting position;

FIG. 4 is a schematic view of the cutting and scrap ejector system of FIG. 1 with a trim portion being ejection by a plunger of the system;

FIG. 5 is a perspective view of a plunger of the cutting and scrap ejector system of FIG. 1;

FIG. 6 is a schematic block diagram showing components of the system of FIG. 1 in accordance with the teachings of the present disclosure; and

FIG. 7 is a flowchart depicting an algorithm for cutting a panel disposed on the system of FIG. 1 in accordance with the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

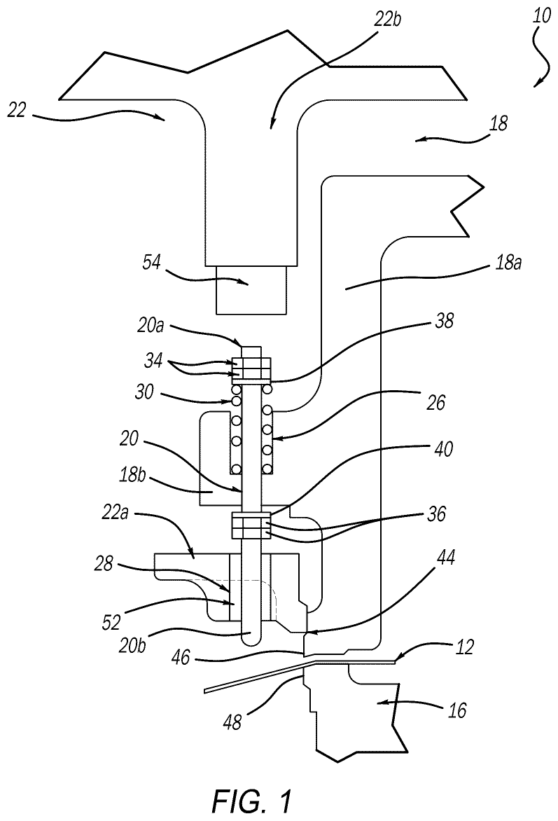

With reference to FIGS. 1-4, a cutting and scrap ejector system or upper die 10 is illustrated. The system 10 may shear or trim a panel or body 12 to a desired shape. The system 10 may also eject and direct the scrap or trimmed off portion of the panel 12 from the system 10 to a desired bolster hole or chute (not shown) to be discarded. In this way, the system 10 may quickly and repeatedly trim the panel 12 and eject the scrap to increase productivity of the stamping operation.

The system 10 includes a lower post 16, a main pad 18, a plunger or rod 20 and a cutting assembly 22. The lower post 16 is disposed below the main pad 18 and partially supports the panel 12. Stated differently, the panel 12 may be disposed or placed on the lower post 16 such that a portion of the panel 12 to be trimmed off extends past a periphery of the lower post 16.

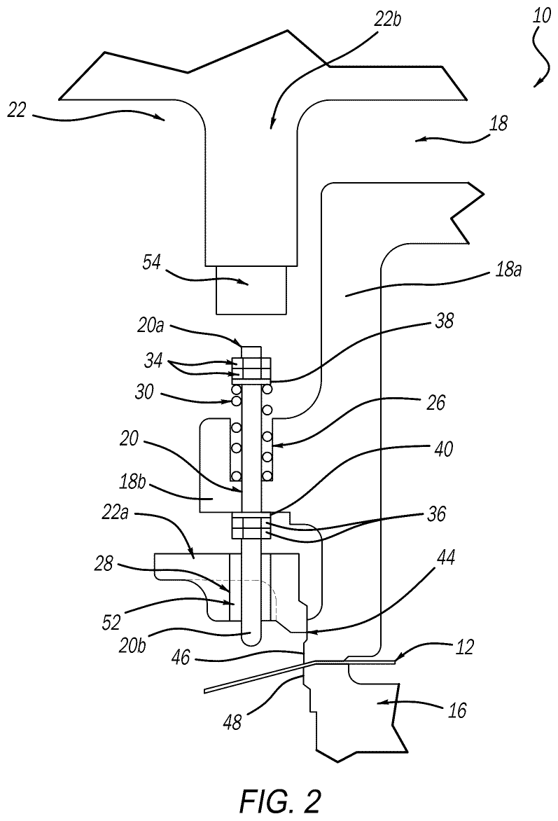

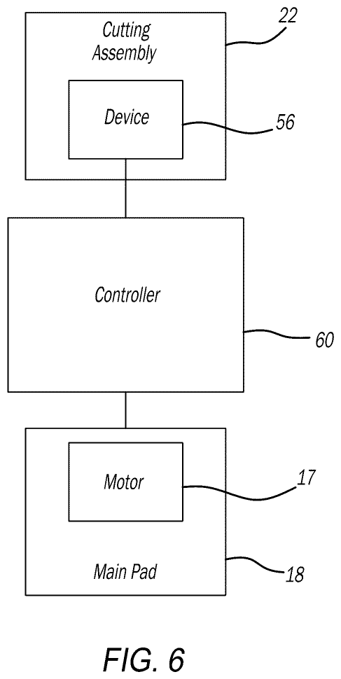

The main pad 18 is movable between a first position (FIG. 1) in which the main pad 18 is spaced apart from the lower post 16 (and the panel 12 disposed on the lower post 16) and a second position (FIGS. 2-4) in which the main pad 18 cooperates with the lower post 16 to grip the panel 12. When the main pad 18 is in the first position, a gap is formed between the main pad 18 and the lower post 16 such that the panel 12 may be placed on the lower post 16. When the main pad 18 is in the second position, a lower surface of the main pad 18 may contact or engage an upper surface of a portion of the panel 12 while an upper surface of the lower post 16 engages a lower surface of a portion of the panel 12 to grip the panel 12. In one form, the main pad 18 may be moved between the first position and the second position by one or more motors 17 (FIG. 6; e.g., hydraulic motor, electric motor, etc.). In other forms, the main pad 18 may be moved between the first position and the second position by another device such as a nitrogen cylinder applying a force or pressure to the main pad 18 using nitrogen gas.

The main pad 18 includes a body portion 18a and an extension portion 18b. The extension portion 18b extends outwardly past a periphery of the body portion 18a (and a periphery of the lower post 16) and defines an opening 26 that is configured to receive the plunger 20 as will be described in more detail below. The extension portion 18b is located between parts of the cutting assembly 22 and the opening 26 extends vertically through the extension portion 18b. Stated differently, the opening 26 opens through an upper side of the extension portion 18b and opens through a lower side of the extension portion 18b. In the example illustrated, the opening 26 is a stepped opening in which a first portion of the opening 26 has a greater diameter than a second portion of the opening 26b.

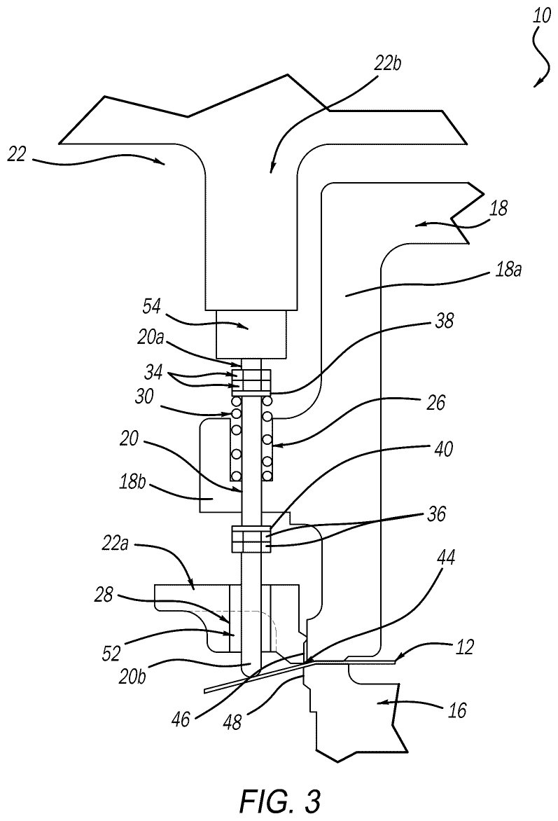

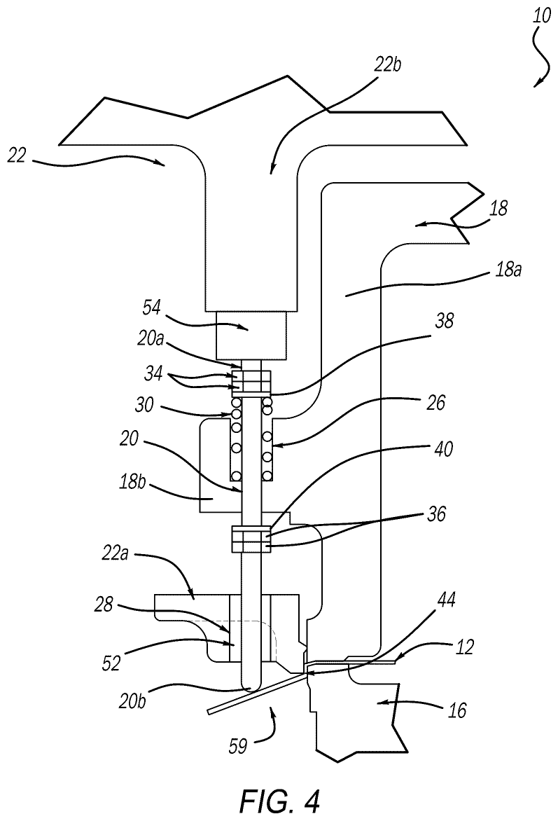

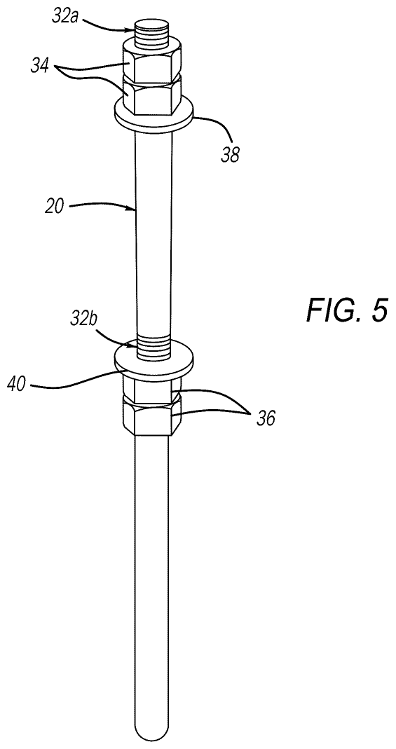

With continued reference to FIGS. 1-4 and additional reference to FIG. 5, the plunger 20 is configured to eject and direct a trimmed or scrap portion of the panel 12 from the system 10 after the panel 12 has been cut. That is, after the panel 12 has been trimmed, the scrap portion of the panel 12 has to be ejected from the system 10 and directed to the chute (not shown). The plunger 20 is configured to eject and direct the trimmed portion of the panel 12 to the chute so that another panel 12 may be loaded onto the system 12 and trimmed. The plunger 20 is movably coupled to the main pad 18 between a first position (FIGS. 1 and 2) in which the plunger 20 is spaced apart from the panel 12 and a second position (FIGS. 3 and 4) in which the plunger 20 contacts a portion of the panel 12 to eject and direct the portion of the panel 12 from the system 10. The plunger 20 is made of a hardened or rigid material and extends through the extension portion 18b and a cutting member 22a of the cutting assembly 22. Stated differently, the plunger 20 extends through the opening 26 of the extension portion 18b and an opening 28 of the cutting member 22a. A biasing member 30 (e.g., spring) is disposed within the first portion of the opening 26 and biases the plunger 20 toward the first position. Stated differently, the biasing member 30 surrounds a portion of the plunger 20 within the first portion of the opening 26 and contacts the plunger 20 to bias the plunger 20 toward the first position.

As shown in FIG. 5, the plunger 20 includes a first threaded portion 32a and a second threaded portion 32b that is spaced apart from the first threaded portion 32a. That is, the first threaded portion 32a is located above the extension portion 18b of the main pad 18 and the second threaded portion 32b is located below the extension portion 18b of the main pad 18 (i.e., the extension portion 18b is disposed between the first and second threaded portions 32a, 32b). One or more nuts 34 are threadably engaged with the first threaded portion 32a and one or more nuts 36 are threabably engaged with the second threaded portion 32b. In this way, the plunger 20 may be adjustable in a vertical direction relative to the main pad 18 (or panel 12) by rotating the plunger 20 relative to the nuts 34, 36.

An upper washer 38 is located between the nuts 34 and the biasing member 30 and engages the nuts 34 and the biasing member 30. In this way, the biasing member 30 biases the plunger 20 toward the first position. A lower washer 40 is located between the nuts 36 and the extension portion 18b of the main pad 18 and may selectively engage the extension portion 18b. That is, when the biasing member 30 biases the plunger 20 toward the first position, the lower washer 40 engages the extension portion 18b. When the plunger 20 moves toward the second position, the lower washer 40 is spaced apart from the extension portion 18b. The plunger 20 also has a proximal end 20a and a distal end 20b. The proximal end 20a is configured to engage the cutting assembly 22 such that the cutting assembly 22 moves the plunger 20 from the first position toward the second position as will be described in more detail below. In the example illustrated, the proximal end 20a has a flat surface. In some forms, the proximal end 20a may have an arcuate surface. The distal end 20b is configured to contact a portion of the panel 12 to eject the portion of the panel 12 from the system 10 and into the chute (not shown). In the example illustrated, the distal end 20b has a rounded or arcuate tip. In some forms, the distal end 20b may have a flat surface or another outer shaped surface that facilitates ejection of the portion of the panel 12 from the system 10 and into the chute.

The cutting assembly 22 is configured to cut or trim the panel 12 and includes the cutting member 22a and an upper shoe 22b. The cutting member 22a is movable between a non-cutting position (FIGS. 1 and 2) in which the cutting member 22a is spaced apart from the panel 12 and a cutting position (FIGS. 3 and 4) in which the cutting member 22a trims the panel 12. The cutting member 22a is movable to the cutting position in response to the main pad 18 and the lower post 16 gripping the panel 12. That is, once the main pad 18 is moved to the second position such that the main pad 18 and the lower post 16 cooperate to grip the panel 12, the cutting member 22a may be moved to the cutting position where a cutting edge 44 of the cutting member 22a trims the panel 12. In the example illustrated, a periphery 46 of the body portion 18a of the main pad 18 is flush with a periphery 48 of the lower post 16. In some forms, the cutting edge 44 may ride along the peripheries 46, 48 of the body portion 18 and the lower post 16, respectively, as the cutting member 22a is moving between the cutting position and the non-cutting position. The plunger 20 is inhibited from contacting the panel 12 prior to the cutting member 22a being moved to the cutting position. In this way, no force is applied to the panel 12 by the plunger 20 until the cutting member 22a beings to trim the panel 12 (or at time period thereafter), which reduces deformation of the panel 12.

The cutting member 22a defines the opening 28 that opens through an upper side of the cutting member 22a and that opens through a lower side of the cutting member 22a. A bushing 52 is disposed within the opening 28 of the cutting member 22a and receives a portion of the plunger 20. Stated differently, the plunger 20 may extend through the bushing 52 where it is supported by the bushing 52 and is movable relative to the bushing 52. In this way, the bushing 52 may inhibit the plunger 20 from bending or flexing as the plunger 20 ejects the trim portion from the system 10 and into the chute. In the example illustrated, an upper axial end of the bushing 52 is flush with an upper surface of the cutting member 22a and a lower axial end of the bushing 52 is flush with a lower surface of the cutting member 22a. In some forms, the upper axial end of the bushing 52 is recessed from the upper surface of the cutting member 22a (i.e. within the opening 28) and the lower axial end of the bushing 52 is recessed from the lower surface of the cutting member 22a (i.e., within the opening 28).

With continued reference to FIGS. 1-4, the upper shoe 22b is connected to the cutting member 22a and moves as the cutting member 22a moves. That is, when the cutting member 22a is in a non-cutting position, the upper shoe 22b is in a first state (FIGS. 1 and 2) and when the cutting member 22a is in a cutting position, the upper shoe 22b is in a second state (FIGS. 3 and 4). The upper shoe 22b includes a striker plate 54 that is configured to engage the proximal end 20a of the plunger 20 to overcome the biasing force of the biasing member 30, thereby moving the plunger 20 from the first position towards the second position. That is, the striker plate 54 is spaced apart from the proximal end 20a of the plunger 20 when the upper shoe 22b is in the first state and engages the proximal end 20a of the plunger 20 when the upper shoe 22b is in the second state. In one form, the upper shoe 22b and the cutting member 22a may be moved by a device 56 (FIG. 6) such as a nitrogen cylinder applying a force or pressure to one or both of the upper shoe 22b and the cutting member 22a using nitrogen gas. In another form, the upper shoe 22b and the cutting member 22a may be moved by one or more motors (e.g., hydraulic motor, electric motor, etc.).

With reference to FIG. 6, the controller 60 is in communication with the device 56 of the cutting assembly 22 and the motors 17 of the main pad 18 and may monitor and control operations of the device 60 and the motor 17 based on data received. In one example, the controller 60 is in communication with the device 60 and the motors 17 using a wireless communication protocol (e.g., a Bluetooth®-type protocol, a cellular protocol, a wireless fidelity (Wi-Fi)-type protocol, a near-field communication (NFC) protocol, an ultra-wideband (UWB) protocol, among others).

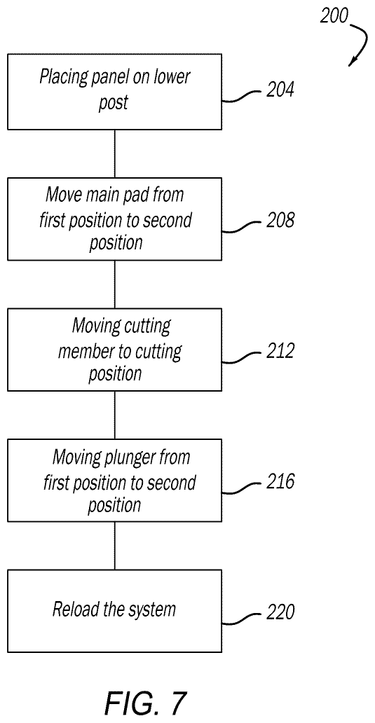

Referring to FIGS. 1-4 and 7, an example control algorithm 200 for cutting the panel 12 and ejecting a trimmed portion of the panel 12 is illustrated. The processing may begin once the main pad 18 is moved to the first position in which the main pad 18 is spaced apart from the lower post 16. At 204, the panel 12 is placed onto the lower post 16 between the main pad 18 and the lower post 16 (FIG. 1). At 208, the control algorithm, using the controller 60, moves the main pad 18 from the first position to the second position such that the main pad 18 and the lower post 16 cooperate to grip the panel 12 (FIG. 2). At 212, the control algorithm, using the controller 60, moves the cutting member from the non-cutting position to the cutting position to cut the panel 12 (FIG. 3). It should be understood that the cutting member 22a is moved from the non-cutting position to the cutting position in response to the main pad 18 and the lower post 16 gripping the panel 12.

At 216, the plunger 20 is moved from the first position to the second position where the plunger 20 contacts a trimmed portion 59 of panel 12 to eject the trimmed portion 59 from the system 10 (FIG. 4) and into the chute. As described above, the plunger 20 is moved from the first position to the second position by the cutting assembly 22 (i.e., the cupper shoe 22b of the cutting assembly 22). It should be understood that the plunger 20 is inhibited from contacting the portion 59 of the panel 12 prior to the cutting member 22a being moved to the cutting position. In this way, the plunger 20 does not apply a force on the panel 12 prior to being cut by the cutting member 22a, thereby inhibiting deformation of the panel 12. At 220, the trimmed panel 12 is removed the from system 10 and the system 10 is reloaded (i.e., another panel 12 is placed onto the lower post 16 to be trimmed).

The system of the present disclosure provides the benefit of permitting the plunger 20 to contact a desired location of the panel 12 during or after the panel 12 has been sheared by the cutting member 22a. In this way, deformation of the panel 12 prior to cutting is inhibited and the trimmed portion 59 of the panel 12 is properly ejected from the system 10 and into the chute. Stated differently, cutting an angled portion of the panel 12 using the cutting member 22a may be desired, however, applying a force to the panel 12 via the plunger 20 prior to the panel 12 being cut may cause the panel 12 to be deformed and also cause the system 10 to malfunction. Therefore, deformation of the panel 12 may be inhibited and proper ejection of the trimmed portion 59 is achieved by permitting the plunger 20 to contact a desired location of the panel 12 during or after the panel 12 has been sheared by the cutting member 22a.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A cutting and scrap ejector system for a panel, the cutting and scrap ejector system comprising:
a lower post configured to at least partially support the panel;
a main pad configured to cooperate with the lower post to grip the panel;
a cutting member movable between a non-cutting position in which the cutting member is configured to be spaced apart from the panel and a cutting position in which the cutting member is configured to trim the panel, the cutting member movable to the cutting position in response to the main pad and the lower post gripping the panel; and
a plunger movably coupled to the main pad between a first position in which the plunger is configured to be spaced apart from the panel and a second position in which the plunger is configured to contact a portion of the panel to eject the portion of the panel from the system, the plunger being moved to the second position once the cutting member is moved to the cutting position,
wherein the plunger is inhibited from contacting the portion of the panel prior to the cutting member being moved to the cutting position.

2. The cutting and scrap ejector system according to claim 1, further comprising a striker plate configured to contact the plunger and move the plunger from the first position toward the second position.

3. The cutting and scrap ejector system according to claim 2, wherein the plunger is adjustable in a vertical direction relative to the main pad.

4. The cutting and scrap ejector system according to claim 1, wherein the plunger extends through the cutting member.

5. The cutting and scrap ejector system according to claim 4, further comprising a bushing disposed within an opening of the cutting member, the plunger extending through the bushing.

6. The cutting and scrap ejector system according to claim 1, further comprising at least one nut threadably engaged to the plunger and configured to adjust the plunger in a vertical direction relative to the main pad.

7. The cutting and scrap ejector system according to claim 1, further comprising a first nut threadably engaged to the plunger and disposed below the main pad and a second nut threadably engaged to the plunger and disposed above the main pad, wherein the first nut and the second nut cooperate to couple the plunger to the main pad.

8. The cutting and scrap ejector system according to claim 1, further comprising a biasing member coupled to the plunger and disposed at least partially within the main pad, the biasing member configured to bias the plunger towards the first position.

9. The cutting and scrap ejector system according to claim 8, further comprising a nut threadably engaged to the plunger and a washer adjacent to the nut, the biasing member coupled to the washer to couple the plunger to the main pad and bias the plunger towards the first position.

10. A cutting and scrap ejector system for a panel, the cutting and scrap ejector system comprising:
a lower post configured to at least partially support the panel;
a main pad configured to cooperate with the lower post to grip the panel;
a cutting member movable between a non-cutting position in which the cutting member is configured to be spaced apart from the panel and a cutting position in which the cutting member is configured to trim the panel, the cutting member movable to the cutting position in response to the main pad and the lower post gripping the panel;
a plunger movably coupled to the main pad between a first position in which the plunger is configured to be spaced apart from the panel and a second position in which the plunger is configured to contact a portion of the panel to eject the portion of the panel from the system, the plunger being moved to the second position once the cutting member is moved to the cutting position, wherein the plunger is inhibited from contacting the portion of the panel prior to the cutting member being moved to the cutting position;
a bushing disposed within an opening of the cutting member, the plunger extending through the bushing; and
a striker plate configured to contact the plunger and move the plunger from the first position toward the second position.

11. The cutting and scrap ejector system according to claim 10, wherein the plunger is adjustable in a vertical direction relative to the main pad.

12. The cutting and scrap ejector system according to claim 10, wherein the plunger extends through the cutting member.

13. The cutting and scrap ejector system according to claim 10, further comprising at least one nut threadably engaged to the plunger and configured to adjust the plunger in a vertical direction relative to the main pad.

14. The cutting and scrap ejector system according to claim 10, further comprising a first nut threadably engaged to the plunger and disposed below the main pad and a second nut threadably engaged to the plunger and disposed above the main pad, wherein the first nut and the second nut cooperate to couple the plunger to the main pad.

15. The cutting and scrap ejector system according to claim 10, further comprising a biasing member coupled to the plunger and disposed at least partially within the main pad, the biasing member configured to bias the plunger towards the first position.

16. The cutting and scrap ejector system according to claim 15, further comprising a nut threadably engaged to the plunger and a washer adjacent to the nut, the biasing member coupled to the washer to couple the plunger to the main pad and bias the plunger towards the first position.

17. A method for trimming and ejecting a body in a scrap ejector system, the method comprising:
placing the body between a main pad of the scrap ejector system and a lower post of the scrap ejector system such that the main pad and the lower post cooperate to grip the body;
moving a cutting member between a non-cutting position in which the cutting member is configured to be spaced apart from the body and a cutting position in which the cutting member is configured to trim the body, the cutting member movable to the cutting position in response to the main pad and the lower post gripping the body; and
moving a plunger between a first position in which the plunger is configured to be spaced apart from the body and a second position in which the plunger is configured to contact a portion of the body to eject the portion of the body from the system,
wherein the plunger is inhibited from contacting the portion of the body prior to the cutting member being moved to the cutting position.

18. The method according to claim 17, wherein at least one nut threadably engaged to the plunger and configured to adjust the plunger in a vertical direction relative to the main pad.

19. The method according to claim 18, wherein the plunger is adjustable in a vertical direction relative to the main pad.

20. The method according to claim 17, further comprising:
biasing the plunger towards the first position using a biasing element; and
moving a striker plate into engagement with the plunger to overcome a biasing force and move the plunger from the first position towards the second position, the plunger being moved to the second position once the cutting member is moved to the cutting position.
